(19) United States
(12) Patent Application Publication
(10) Pub. No.: US 2014/0056003 A1
(43) Pub. Date: Feb. 27, 2014

(54) MODULAR VIDEO AND LIGHTING DISPLAYS

(71) Applicant: John Frattalone, New York, NY (US)

(72) Inventor: John Frattalone, New York, NY (US)

(21) Appl. No.: 13/971,412

(22) Filed: Aug. 20, 2013

Related U.S. Application Data
(60) Provisional application No. 61/691,063, filed on Aug. 20, 2012.

(51) Int. Cl. F21K 99/00

(52) U.S. Cl. CPC F21K 9/30
USPC 362/249.06

(57) ABSTRACT

Modular video and lighting displays are provided. These displays include one or more modular display tiles that may present a seamless image to a viewer. Each modular display tile has a first surface and a second surface opposite the first surface in addition to an array of LEDs disposed on the first surface in a hexagonal grid configuration. The array of LEDs is configured to provide at least one clean line of separation within the array at a non-right angle and thereby enable uniquely shaped modular display tiles to be created.

### RELATED APPLICATION

This application claims priority under 35 U.S.C. §119(e) to U.S. Provisional Application No. 61/691,063, entitled “TRIANGULAR/HEXAGONAL LAYOUT OF PIXELS FOR VIDEO AND LIGHTING DISPLAYS,” filed Aug. 20, 2012, which is hereby incorporated by reference in its entirety for all purposes.

### BACKGROUND

1. Technical Field

Aspects of the present disclosure relate to methods and systems for modular video and lighting displays.

2. Discussion

There are many different types of displays for presenting an image, or a stream of video images, to a viewer. These displays include Light Emitting Diode (LED) displays, Liquid Crystal Displays (LCD), Plasma Display Panels (PDP), and Cathode Ray Tube (CRT) displays, all of which typically present two-dimensional images to a viewer on a rectangular two-dimensional display. Such displays are generally composed of a plurality of individually controllable light sources (e.g., pixels) which are operated to present a desired image and/or desired video images to the viewer.

The plurality of individually controllable light sources is commonly arranged in a standard square grid configuration across a display. In the case of the LED displays, these individually controllable light sources may comprise LEDs. In other cases, a white backlight illuminates a plurality of individually controllable square filters to obtain the desired color and intensity.

### SUMMARY

Aspects of the present disclosure relate to a modular LED display tile. The modular LED display tile includes an array of LEDs disposed on a surface of the tile in a hexagonal configuration. In some embodiments, the LED display tiles are modular triangular tiles that may be combined to form a display that is capable of presenting a seamless image to a viewer. The seamless image is achieved by spacing the LEDs in such a fashion as to maintain a constant pattern (i.e., the hexagonal grid) across the plurality of modular LED display tiles of the display. These modular tiles may also enable display screens of unique sizes and shapes to be formed without the introduction of visible gaps between the LED display tiles that comprise the display screens. It is appreciated that the modular LED display tiles are not limited to two-dimensional displays. In some embodiments, the LED display tiles may be combined to form custom three-dimensional displays (e.g., polyhedral shaped displays).

According to one aspect, a Light Emitting Diode (LED) display is provided. The LED display includes a modular tile having a first surface and a second surface opposite the first surface in addition to an array of LEDs disposed on the first surface in a hexagonal grid configuration. The array of LEDs is configured to provide at least one clean line of separation within the array at a non-right angle.

According to one embodiment, the array of LEDs disposed on the first surface in the hexagonal configuration includes an array of LED pixels disposed on the first surface in the hexagonal configuration. In this embodiment, each LED pixel of the array of LED pixels may include at least a red LED subpixel, a blue LED subpixel, and a green LED subpixel. According to another embodiment, the LEDs disposed on the first side in the hexagonal configuration are 3-fold rotationally symmetric about an axis perpendicular to the first surface.

According to one embodiment, the modular tile includes a plurality of triangular sub-sections with identical dimensions. In this embodiment, each one of the plurality of triangular subsections may include at least one LED disposed at a central point of the triangular subsection. According to one embodiment, each of the plurality of triangular subsections is an equilateral triangular subsection and the plurality of triangular subsections form a regular hexagonal grid across the first surface of the modular tile. According to one embodiment, each of the plurality of triangular subsections is an isosceles triangular subsection and the plurality of triangular subsections form a stretched hexagonal grid across the first surface of the modular tile. According to one embodiment, each of the plurality of triangular subsections is a scalene triangular subsection and the plurality of triangular subsections form a skewed hexagonal grid across the first surface of the modular tile. According to one embodiment, the modular tile is a triangular tile.

According to one aspect, a Light Emitting Diode (LED) display is provided. The LED display includes a plurality of modular tiles, each of the plurality of tiles having a first surface and a second surface opposite the first surface. Each of the plurality of tiles further include an array of LEDs disposed on the first surface in a hexagonal grid configuration wherein the array of LEDs is configured to provide at least one clean line of separation within the array at a non-right angle.

According to one embodiment, the plurality of modular tiles is configured to present a seamless image across the LED display to a viewer of the LED display. According to one embodiment, the array of LEDs of each one of the plurality of modular tiles is arranged to form a continuous hexagonal grid configuration across the plurality of modular tiles to present the seamless image to the viewer of the LED display.

According to one embodiment, each array of LEDs disposed on the first surface in the hexagonal configuration includes an array of LED pixels disposed on the first surface in the hexagonal configuration. According to one embodiment, each LED pixel in the array of LED pixels includes at least a red LED subpixel, a blue LED subpixel, and a green LED subpixel.

According to one embodiment, the plurality of modular tiles includes a plurality of triangular tiles. According to one embodiment, the plurality of modular tiles are arranged to form at least one polyhedron.

According to one aspect, a method for providing an LED display is provided. The method includes providing at least one modular tile having a first surface and a second surface opposite the first surface and providing an array of LEDs disposed on the first surface in a hexagonal grid configuration wherein the array of LEDs is configured to provide at least one clean line of separation within the array at a non-right angle.

According to one embodiment, the LEDs disposed on the first side in the hexagonal configuration are 3-fold rotationally symmetric about an axis perpendicular to the first surface. According to one embodiment, providing at least one modular tile includes providing at least one modular tile that includes a plurality of triangular sub-sections with identical dimensions.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 illustrates an embodiment of a regular hexagonal pattern;

FIG. 2 illustrates an embodiment of a regular hexagonal grid;

FIG. 3 is a table illustrating various hexagonal grid types;

FIGS. 4A-B are tables illustrating various triangle centers;

FIG. 5 is a table illustrating skewed hexagonal grids formed from light source placement within scalene triangles consistent with various central points;

FIG. 6 is a table illustrating 3-fold symmetric patterns;

FIG. 7 is a table illustrating 3-fold symmetric grid patterns;

FIG. 8 illustrates an embodiment of a back side of a triangular modular tile;

FIG. 9 illustrates another embodiment of a back side of a triangular modular tile;

FIGS. 10A-D illustrate various embodiments of modular tiles;

FIG. 11A-B illustrate various embodiments of modular tiles;

FIG. 12 illustrates an embodiment of a back side of an example display screen;

FIG. 13 illustrates another embodiment of an example display screen;

FIG. 14 illustrates another embodiment of an example display screen;

FIG. 15 illustrates an embodiment of an example three-dimensional display screen (e.g., a tetrahedron);

FIG. 16 illustrates another embodiment of an example three-dimensional display screen;

FIGS. 17A-B illustrate one embodiment of a modular tile support structure;

FIGS. 18A-B illustrate one embodiment of a strut; and

FIGS. 19A-B illustrate another embodiment of a strut.

### DETAILED DESCRIPTION

As discussed above, common displays for presenting an image, or a stream of video images, to a viewer typically includes a plurality of individually controllable light sources (e.g., pixels) that are driven to present a desired image and/or desired video images to the viewer. The plurality of light sources is commonly arranged in a standard square grid configuration across the display. For example, the standard square grid configuration may comprise a plurality of light sources that are placed at the intersection of a square lattice. However, such a configuration of the plurality of light sources limits the possible sub-division of the screen into shapes with perpendicular intersections (i.e., dividing lines at 90 degree angles to, or parallel to, the screen's edge).

Accordingly, embodiments described herein provide systems and methods for modular video and lighting displays capable of providing seamless images to a viewer. According to some embodiments, a modular video and lighting display includes modular LED display tiles that are coupled together and configured to present a seamless image to a viewer. According to one embodiment, the modular LED display tiles are modular triangular LED display tiles; however, in other embodiments, differently shaped modular LED display tiles may be utilized (e.g., trapezoidal, hexagonal, or parallelogram shaped tiles). The seamless image may be achieved by spacing the LEDs of each tile in a hexagonal configuration across each tile in such a way as to maintain a constant pattern throughout the plurality of modular LED display tiles of the modular video and lighting display. It is appreciated that the pattern employed may be any pattern that is a multiple of 3-fold rotational symmetry (e.g., 6-fold rotational symmetry) to form orientation-neutral modular tiles. This pattern may include, for example, a hexagonal layout of pixels. The hexagonal layout of pixels offers a 6-fold rotationally symmetric pattern that allows for the creation of orientation-neutral modular tiles.

In some embodiments, the hexagonal pattern of pixels allows clean subdivision (i.e., clean lines of separation) of the hexagonal pattern into sections with angles other than 90 degrees (e.g., in shapes other than rectangles or squares). For example, a hexagonal layout of pixels can be split into 3 or 6 pie slice sections that are rotationally symmetric around a central point. In contrast, a standard square grid configuration, as discussed above, can only be halved or quartered while remaining rotationally symmetric around a central point. It is appreciated that the hexagonal pattern is not limited to regular hexagonal patterns. The hexagonal pattern may, for example, be a stretched or a skewed hexagonal pattern. These patterns may be employed on two-dimensional planes or on the surface of 3-dimensional objects (e.g., polyhedrons).

The hexagonal pattern has a plurality of properties as described above (e.g., clean lines of separation). In addition, the hexagonal pattern enables seamlessness across a display comprising a plurality of modular tiles. Seamlessness enables a video or image to be presented to a viewer without the viewer being able to discern where specific modular tiles meet. The hexagonal pattern allows seamlessness because a continuous pattern may be formed across a display with relatively consistent spacing between pixels. This consistent spacing taken in combination with the continuous pattern may make the seams indiscernible to a viewer.

It is to be appreciated that embodiments described herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements, and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

### Hexagonal Layout

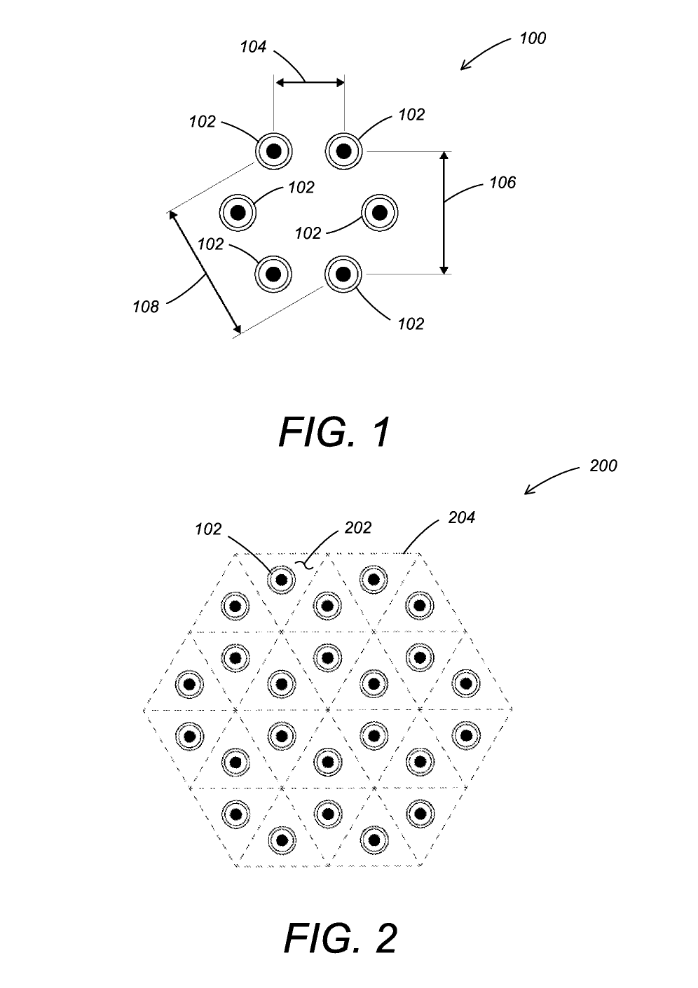

Various examples disclosed herein implement a hexagonal layout of light sources within a modular display (e.g., a modular tile). For example, FIG. 1 illustrates an embodiment of a regular hexagonal pattern 100. As shown, the hexagonal layout 100 includes light sources 102 and a plurality of dimensions defining the regular hexagonal pattern. These dimensions include a side length 104, a height 106, and a diagonal length 108.

Regular hexagons include six-sided polygons with equal side lengths. The regular hexagonal pattern may be characterized by three distances (e.g., the side length 104, the height 106, and the diagonal length 108) formed by drawing a right triangle between three vertices of the hexagon. The regular hexagonal pattern 100 is formed by placing light sources 102 at each of the vertices of the regular hexagon.

It is appreciated that each light source 102 may include a plurality of light sources. For example, the light source 102 may include an LED pixel. According to one embodiment, the LED pixel may comprise three or more LEDs including a red LED, a green LED, a blue LED, a white LED, or any other type of LED. The combination of the light from the red, green, and blue LEDs may be used to form various colors in the RGB color space. In other embodiments, the light source 102 may include incandescent bulbs, fluorescent bulbs, or any other type of appropriate light source.

The regular hexagonal pattern 100 may be repeated any number of times to form a regular hexagonal grid as illustrated in FIG. 2. FIG. 2 illustrates an embodiment of a regular hexagonal grid 200. The regular hexagonal grid 200 comprises light sources 102 and may be subdivided into a plurality of triangles 202 formed by subsection lines 204.

The regular hexagonal grid 200 may be subdivided into a plurality of equal triangular subsections 202. These subsections may be equilateral triangles (i.e., triangles with 3 equal length sides). It is appreciated that the triangular subsections are not limited to triangular subsections that include a single light source 102, but may include multiple light sources 102. The regular hexagonal grid may be subdivided into larger or smaller triangular subsections.

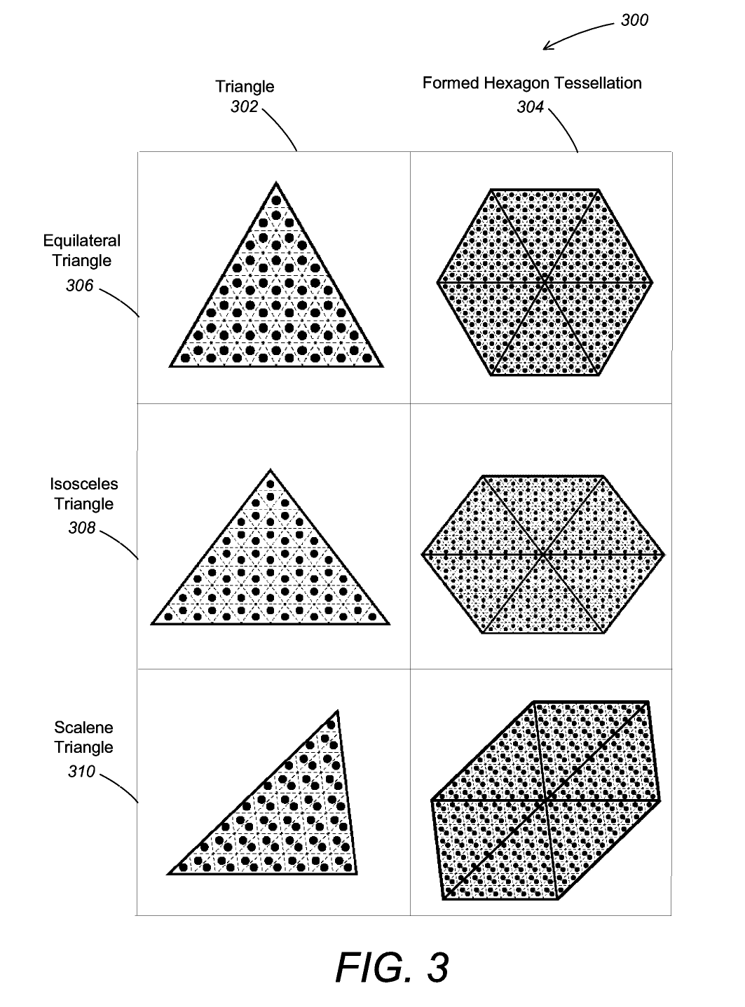

In addition, various types of hexagonal grids (e.g., stretched hexagonal grids and skewed hexagonal grids) may be subdivided into various types of triangles (e.g., isosceles triangles and scalene triangles). For example, various hexagonal grids may be formed based on the underlying sub-triangle type in each grid or vice-versa. FIG. 3 illustrates embodiments of various types of hexagonal grid patterns formed from various types of sub-triangles through hexagonal grid table 300. The hexagonal grid table 300 includes a triangle type column 302 and a formed hexagon type column 304 for a set of triangle types including an equilateral triangle row 306, an isosceles triangle row 308, and a scalene triangle row 310.

As illustrated by the equilateral triangle row 306, a regular hexagon and a regular hexagonal grid may be formed from equilateral sub-triangles. The isosceles triangle row 308 illustrates that a stretched hexagon and a stretched hexagonal pattern may be formed from isosceles sub-triangles. The scalene triangle row 310 illustrates that skewed hexagons and a corresponding skewed hexagonal grid may be formed by scalene sub-triangles.

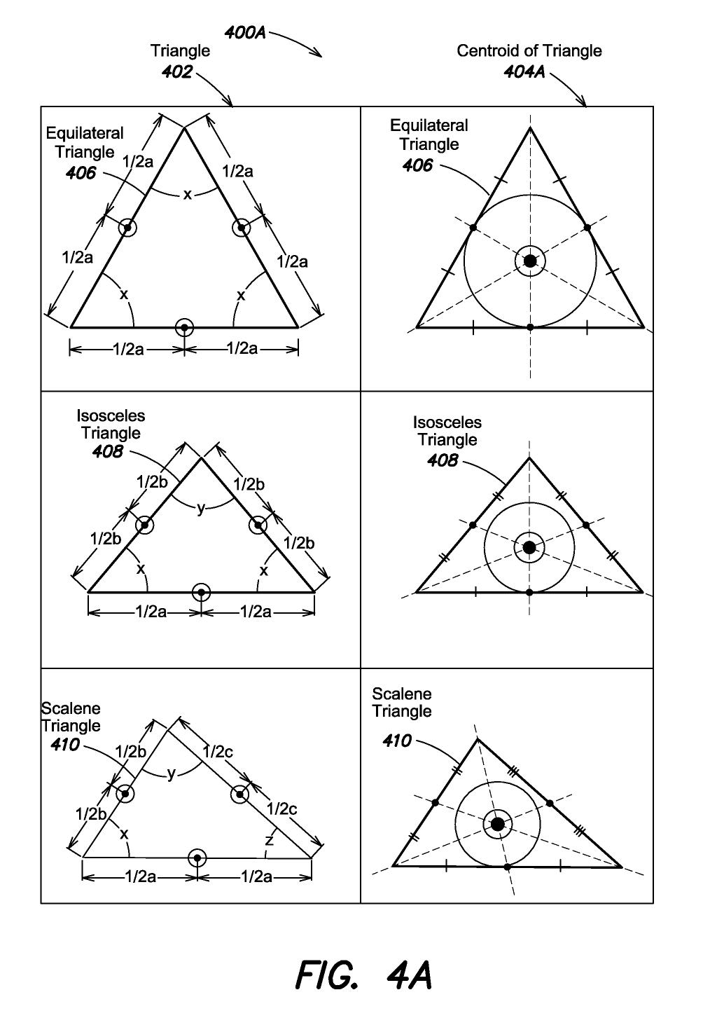

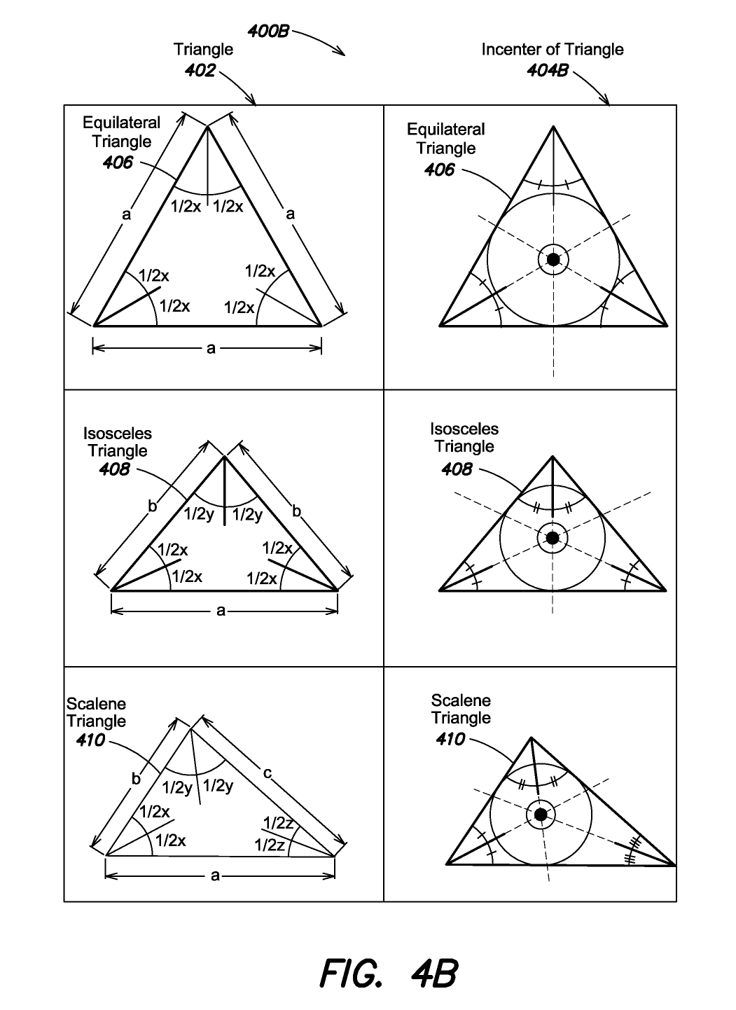

It is appreciated that the light source within each sub-triangle is not necessarily at the centroid of each triangle. The light source within each sub-triangle may be placed at any number of different possible triangle centers (e.g., the gergonne point, the fermat point, etc.). FIGS. 4A-B illustrate various light source centers via a triangle centroid table 400A and a triangle incenter table 400B. The triangle centroid table 400A includes a triangle type column 402 and a triangle centroid column 404A in addition to an equilateral triangle row 406, an isosceles triangle row 408, and a scalene triangle row 410.

As illustrated in the triangle centroid table 400A, the centroid of each triangle may be characterized by a point at the intersection of three lines. Each of the intersecting lines starts at a vertex of the triangle and ends at a bisection of the opposing side. It is appreciated that other types of triangle centers may be used (e.g., the incenter of a triangle). The triangle incenter table 400 includes a triangle type column 402 and a triangle incenter column 404B in addition to an equilateral triangle row 406, an isosceles triangle row 408, and a scalene triangle row 410.

As illustrated in the triangle incenter table 400B, the incenter of each triangle may be characterized by a point at the intersection of three lines. Each of the intersecting lines starts at a vertex of the triangle and extends in a direction that bisects the interior angle associated with said vertex. As illustrated by the triangle centroid table 400A and triangle incenter table 400B, multiple center point types may yield the same result. For example, the equilateral triangle as illustrated in row 406 of the triangle centroid table 400A and triangle incenter table 400B has the same incenter and centroid point. However, scalene and isosceles triangles may have differing incenter and centroid points. Therefore, light source placement consistent with various types of center points may produce different hexagonal grids (e.g., variations of skewed grids in the case of scalene sub-triangles).

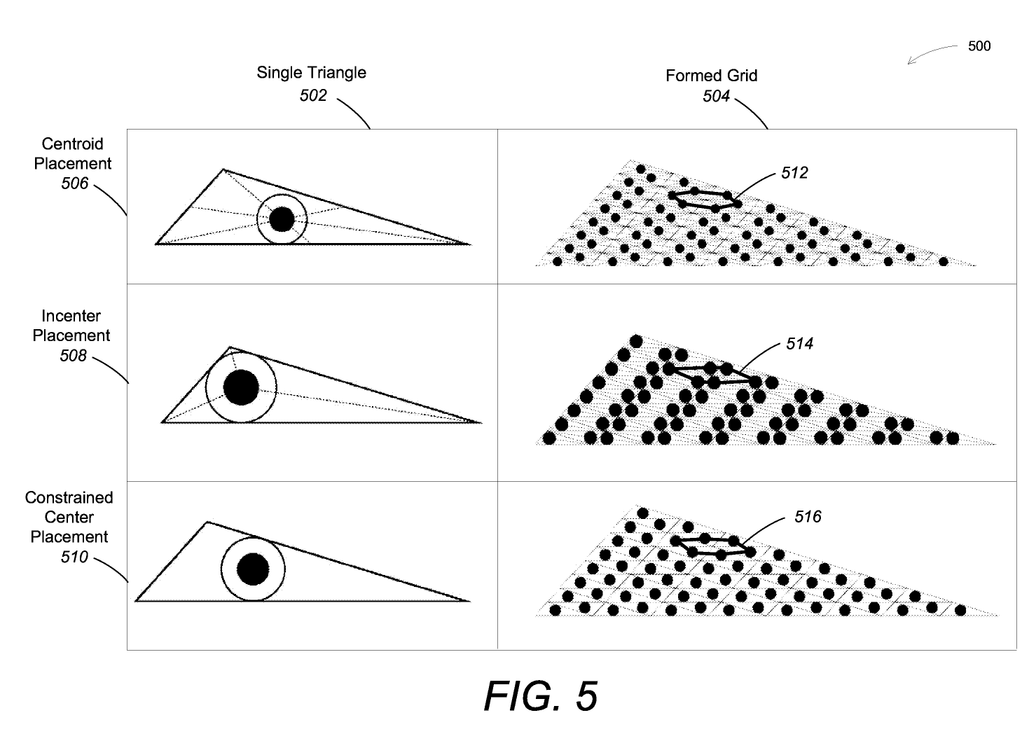

FIG. 5 illustrates various skewed hexagonal grids formed from light source placement within scalene triangles consistent with various central points. FIG. 5 comprises a grid table 500 that includes triangle center type column 502 and a formed grid column 504 in addition to centroid placement row 506, incenter placement row 508, and constrained center placement row 510. The skewed hexagons formed in each grid are illustrated by the centroid placement formed hexagon 512, incenter placement formed hexagon 514, and the constrained center placement formed hexagon 516.

As illustrated by the centroid placement row 506, the formed skewed hexagonal grid has relatively uneven spacing. This uneven distribution of light sources across a plane may introduce distortion into the displayed image or create visible gaps between the light sources. As illustrated by the centroid placement formed hexagon 512, the side lengths of hexagon 512 are substantially uneven. Placing the light source consistent with an incenter of each triangle may further the uneven distribution of light sources as illustrated by the formed hexagon 514.

In some embodiments, the light source is placed consistent with one or more constraints to distribute the light sources evenly across the surface. The constraints may include positioning the light source within the scalene triangle such that the hexagon formed by connecting six light sources has relatively even side lengths. These constraints are illustrated by the formed hexagon 516 in the constrained center placement. The resultant skewed hexagonal grid has an even distribution across the surface that subsequently presents an image without the introduction of image distortion or gaps between light sources.

It is appreciated that alternative layouts may be employed that maintain the 3-fold symmetry required for the creation of modular display tiles. For example, alternative patterns may be generated by further dividing each sub-triangle into three identical regions.

### Alternative Layouts

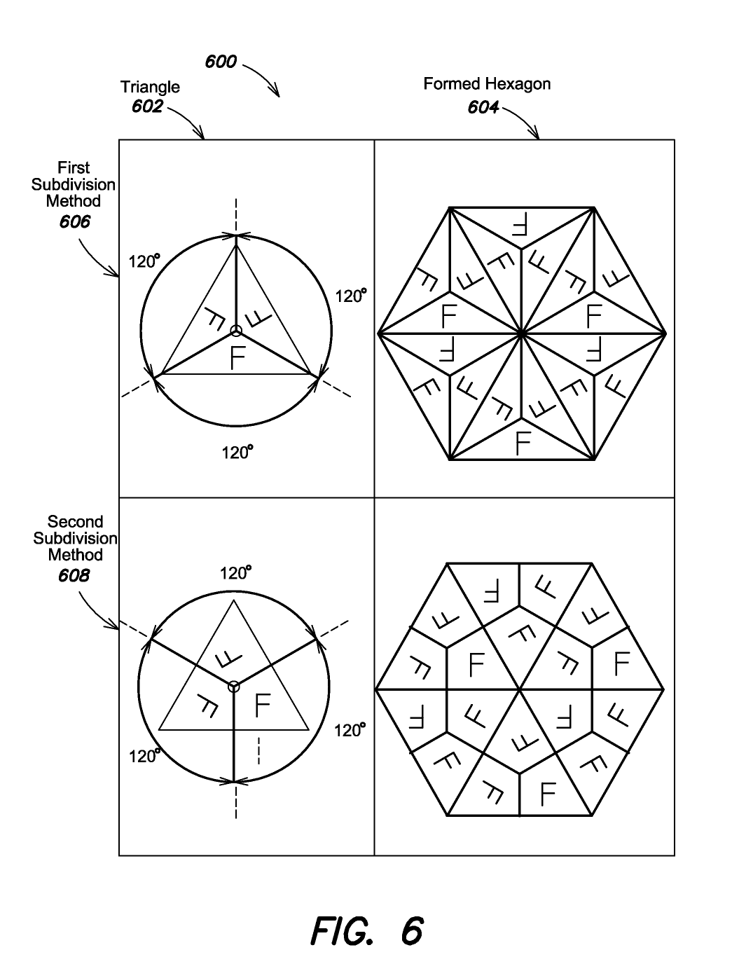

As described above, a variety of 3-fold symmetric light source configurations can be employed to create modular display tiles. FIG. 6 illustrates other 3-fold symmetric patterns in the 3-fold symmetric triangle table 600. The 3-fold symmetric triangle 600 table includes the triangle column 602 and the formed grid column 604 in addition to a first pattern row 606, a second pattern row 608.

As illustrated by the 3-fold symmetric triangle table 600, 3-fold symmetric patterns may be formed by subdividing a triangle into three identical subsections. These patterns can be repeated to form larger tessellations. Light sources may be placed in various patterns within each of the three identical triangle subsections to form various grids. It is appreciated that triangles may be subdivided into non-triangular subsections as illustrated by the second division method row 608. For example, the subunits labeled “F” in the formed hexagon consistent with the second subdivision method are quadrilateral subsections. These subunits could stand alone and form individual modular tiles that may seamlessly tile a plane and/or surface.

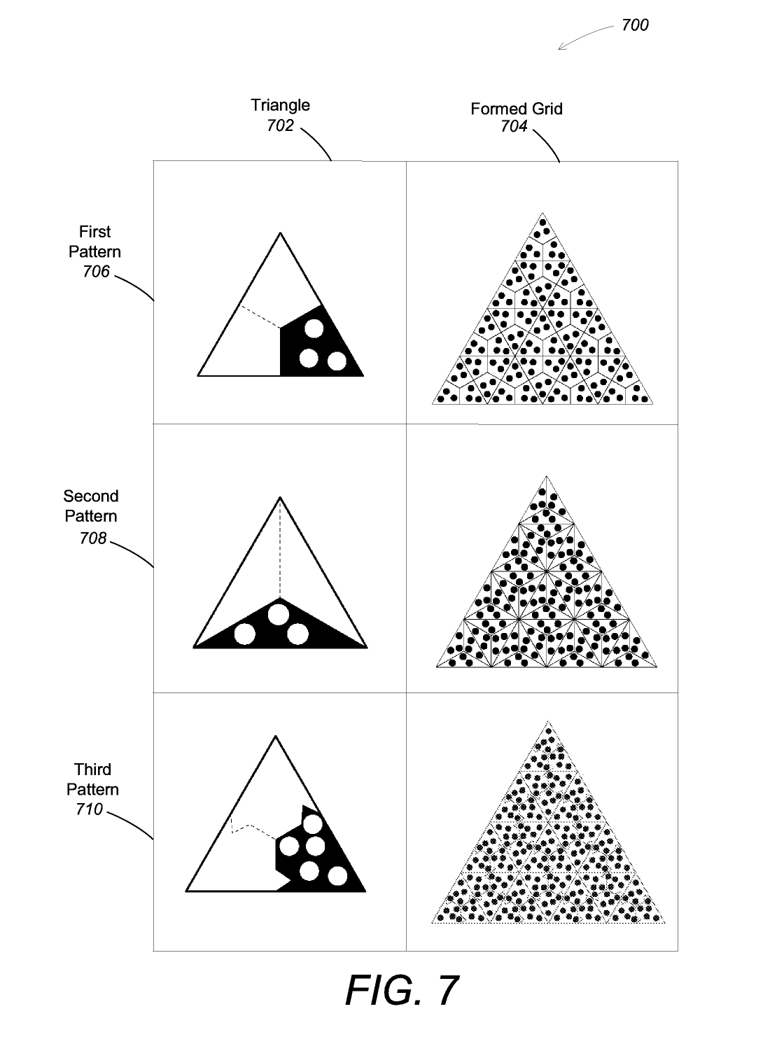

FIG. 7 illustrates specific light source patterns that may be implemented while retaining the 3-fold symmetry. The 3-fold symmetric pattern table 700 includes a triangle column and a formed grid column in addition to a set of patterns illustrated by the first pattern row 706, the second pattern row 708, and the third pattern row 710.

As illustrated in the 3-fold symmetric pattern table 700, various orientation-neutral alternative patterns may be formed. Displays formed from these patterns present a seamless image to a viewer because of the orientation-neutral modules. The viewer may, however, be able to see the basic repeating pixel pattern in the presented image. In contrast, a regular hexagonal grid as illustrated in FIG. 2 may present a seamless image to a viewer in addition to making the repeating light source pattern (e.g., the repeating hexagon pattern) indiscernible to a viewer.

### Modular Display Tile

In some embodiments, the various hexagonal layouts described above are utilized to form modular tiles. These tiles may, for example, include triangular tiles that can form any screen that can be decomposed into one or more triangles. Various shaped screens that can be decomposed into one or more triangles include, but may not be limited to, hexagonal screens, trapezoidal screens, and parallelogram screens. It is appreciated that these modular tiles are interchangeable in a display and may be re-used to form new displays of unique shapes and sizes.

In one embodiment, the lights sources associated with each of the modular tiles are uniquely addressable. The individual addressability of each tile enables video content to be mapped to the unique sizes and shapes of formed display screens. In this embodiment, the modular tiles include connections to receive control signals and power from an external system. These tiles may be designed to optimize the routing of cables throughout displays formed from a plurality of modular tiles.

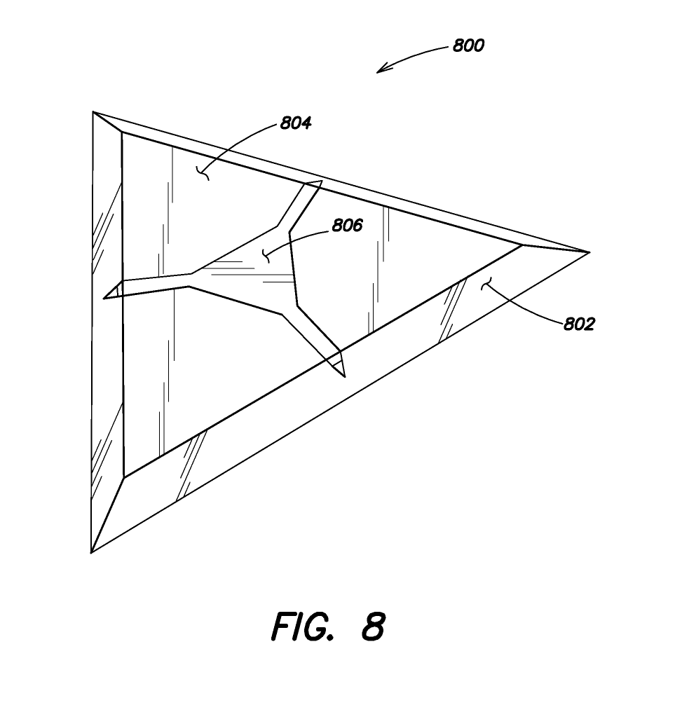

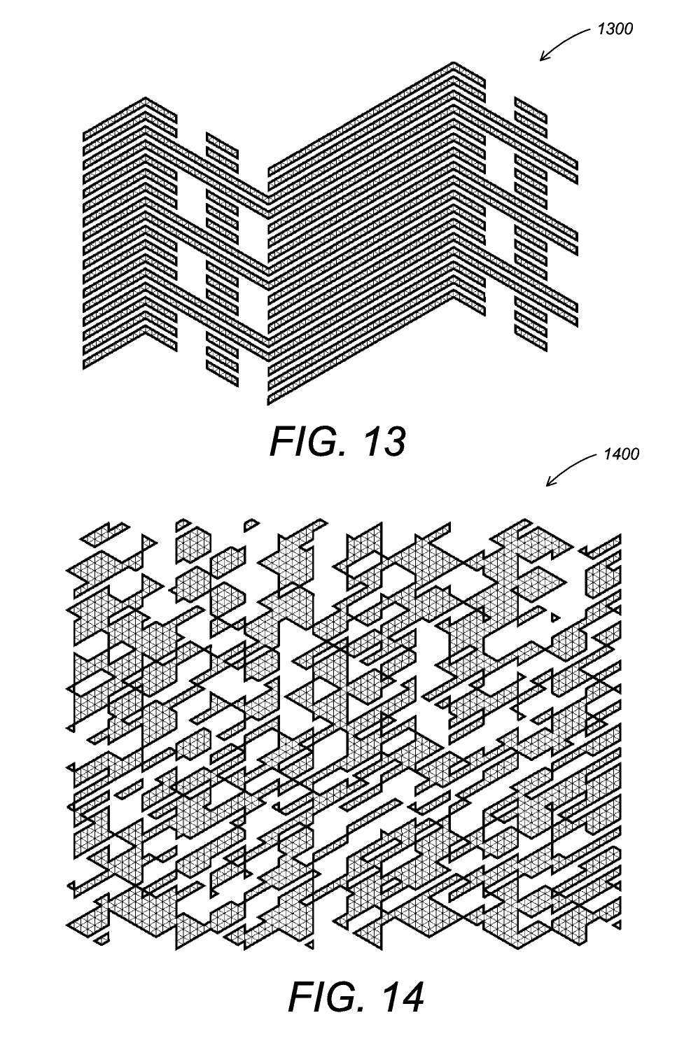

FIG. 8 illustrates a modular display tile that is uniquely addressable. The modular triangular tile 800 includes a beveled edge 802, a back surface 804, and a cover plate 806. The beveled edge 802 may be beveled so as to enable placement of tiles in 3-dimensional displays as described in the Example Displays section and FIGS. 13 and 14.

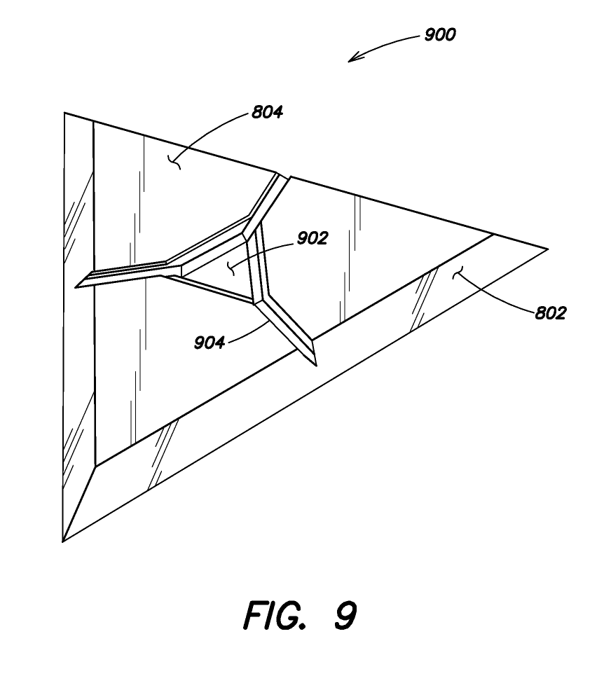

Removing the cover plate 806 reveals I/O connection termination points and cable channels as illustrated in FIG. 9. The coverless modular triangular tile 900 includes an I/O termination location 902 and a cable routing channel 904 in addition to the beveled edge 802 and the rear surface 804.

The cable routing channel 904 allows cables transmitting power and/or signal information from an external entity. The channel provides a path for cables to be routed during panel installation. In some embodiments, the beveled edges 802 function as cable channels when the triangular tiles 800 are part of a two-dimensional display. In these embodiments, the I/O connection points may be placed on the beveled edges of each triangle tile and obviate the cable channel 904.

In one embodiment, the modular triangular tile 800 has a side length between 3 cm 150 cm in addition to a pixel pitch between 1 mm 150 mm. For example, the modular triangular tile may be an equilateral triangle with a side length of 96 mm that contains 64 total pixels (8 pixels per side) with RBG LED pixels.

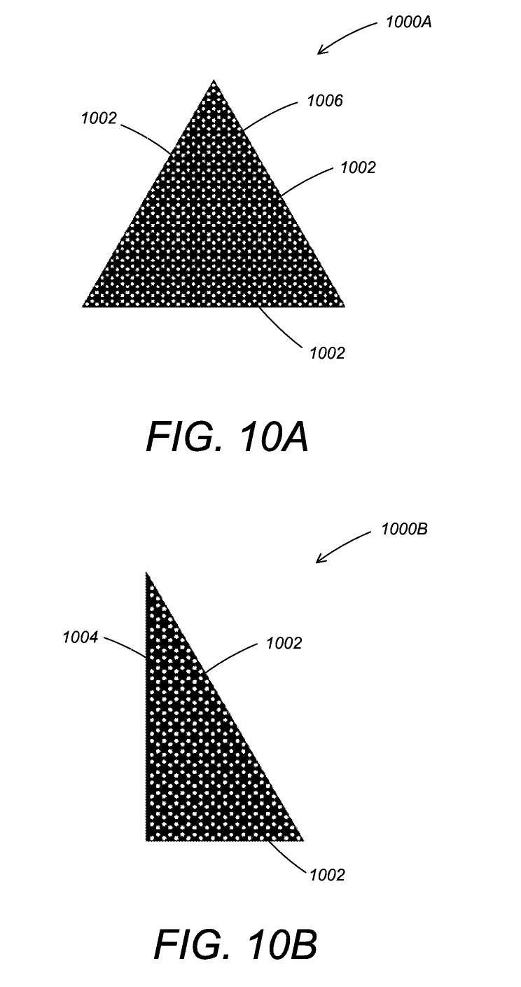

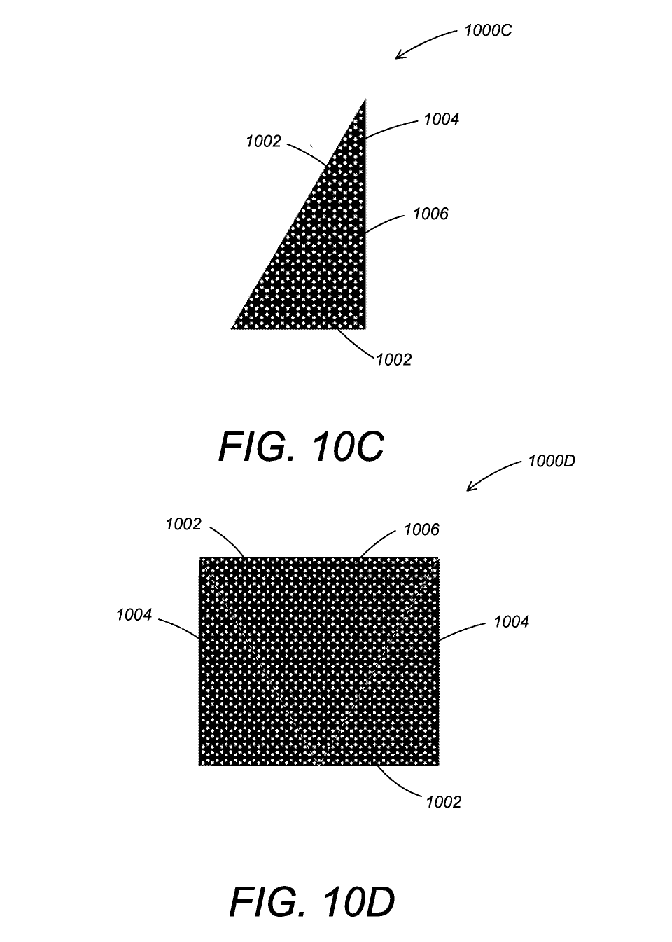

FIGS. 10A-D illustrate various embodiments of modular tiles that employ light sources in a regular hexagonal grid. The equilateral triangle tile 1000A includes tiling edges 1002 and light sources arranged in a regular hexagonal grid 1006. The equilateral triangle tile 1000A is orientation neutral and, therefore, has three tiling edges 1002 that can tile with any tiling edge from another equilateral triangle tile 1000A. It is appreciated that tiling edges, such as tiling edge 1002, allow two tiles to meet at that edge and present a continuous hexagonal pattern across both tiles and thereby enable a seamless image to be presented to a viewer.

The first right triangle tile 1000B and the second right triangle tile 1000C each include tiling edges 1002, non-tiling edges 1004, and light sources arranged in a regular hexagonal grid 1006. In contrast to the equilateral triangle tile 1000A, the right triangle tiles 1000B-C are not orientation neutral and, therefore, can only tile seamlessly when specific pairs of edges meet. The non-tiling edges 1004 cannot tile with another tile and maintain the regular hexagonal grid. The tiling edges 1002 of the right triangle tiles 1000B-C may tile seamlessly with tiling edges 1002 of the equilateral triangle tile 1000A. The combination of the right triangle tiles 1000B-C with the equilateral triangle 1000A form a rectangle as illustrated by element 1000D in FIG. 1000D.

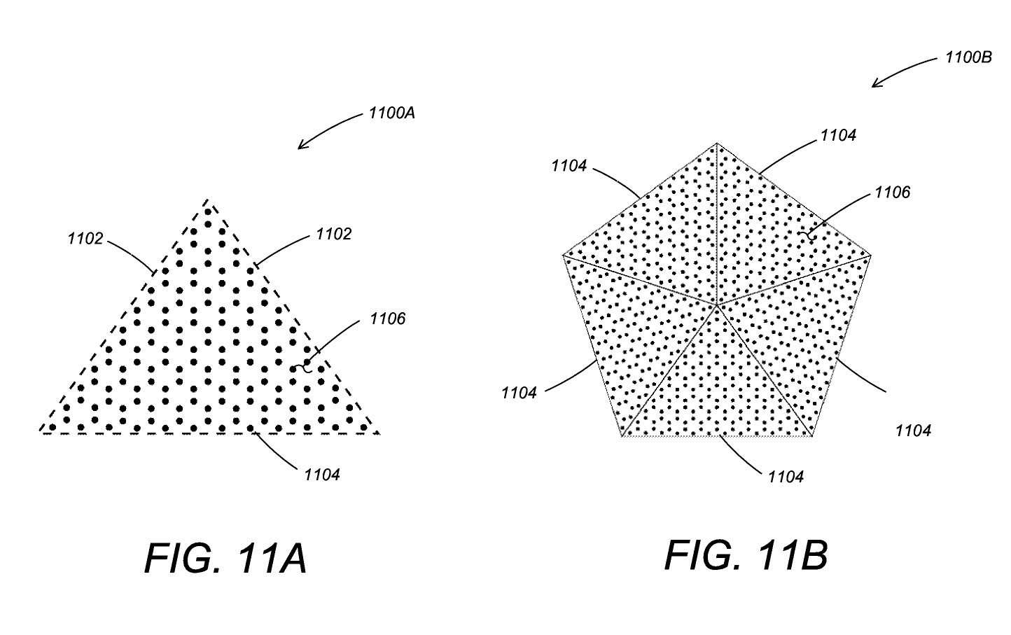

FIGS. 11A-B illustrate various embodiments of modular tiles that employ light sources arranged in a stretched hexagonal grid. The isosceles triangular tile 1100A includes first tiling edges 1102, second tiling edge 1104, and light sources arranged in a stretched hexagonal grid 1106. The isosceles triangular tile 1100A is not orientation neutral and, therefore, can only tile seamlessly when specific pairs of edges meet. This is illustrated by the first tiling edges 1102 and the second tiling edge 1104. The first tiling edges 1102 tile seamlessly with any first tiling edge 1102 from another isosceles triangular tile 1100A as illustrated by the formed pentagon 1100B in FIG. 11B. In addition, the second tiling edge 1104 tiles seamlessly with the second tiling edge 1104 from another isosceles triangular tile 1100A. This subsequently forms a parallelogram with four tiling edges 1102 that can be employed to tile a plane.

It is appreciated that a plurality of modular tiles may be combined to form displays of various shapes and sizes. Smaller applications for this arrangement could come in the form of products that require the arrangement of very small pixels at very tight pitches, such as consumer displays (e.g., home TVs) and handheld devices (e.g., smartphone displays). Larger applications for this arrangement could come in the form of fixtures that are non-rigid or semi-rigid soft curtain products, such as current LED curtain products. In addition, custom scenic elements may be tiled with larger, single pixel LED products such as pucks and spheres. Much larger applications for this arrangement of pixels could come in the form of very large, custom pixels (e.g., 300 cm diameter pixels) used to tile the whole side of a triangular building (e.g., a hotel in the shape of a pyramid or having a triangular surface).

### Example Displays

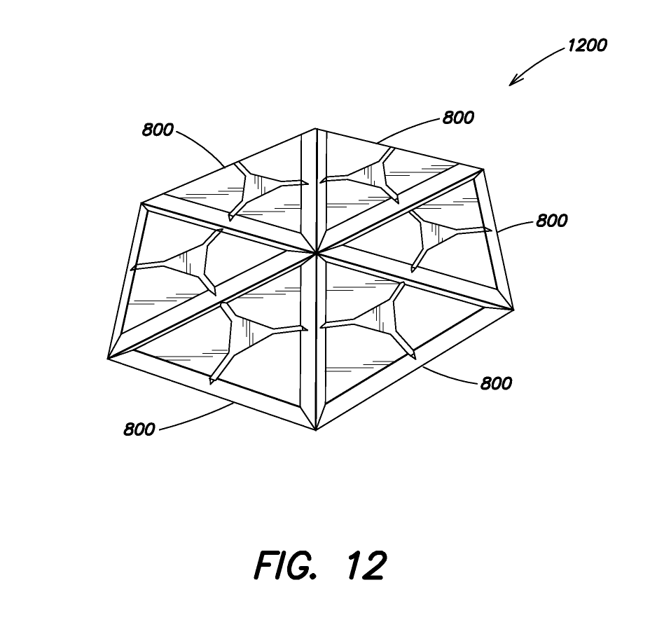

In various embodiments, the modular display tile described above is used to form displays of unique shapes. These shapes include two-dimensional planar displays and three-dimensional displays. FIGS. 12-14 illustrate various screens composed of a plurality of triangular modular tiles. These displays can range in size from small high definition displays to large displays that cover the side of buildings. These displays also allow designers to utilize negative space (i.e., space where tiles are purposefully omitted).

FIG. 12 illustrates the back-side of an example hexagonal screen 1200 comprising six triangular modular tiles 800. An array of LEDs on the front side (not shown) of each modular tile 800 may combine with the array of LEDs of each other modular tiles 800 to form the desired hexagonal display screen across the six tiles. However, such display screens may be increasingly more ornate as illustrated by the tile designs 1300 and 1400 illustrated in FIG. 13 and FIG. 14 respectively.

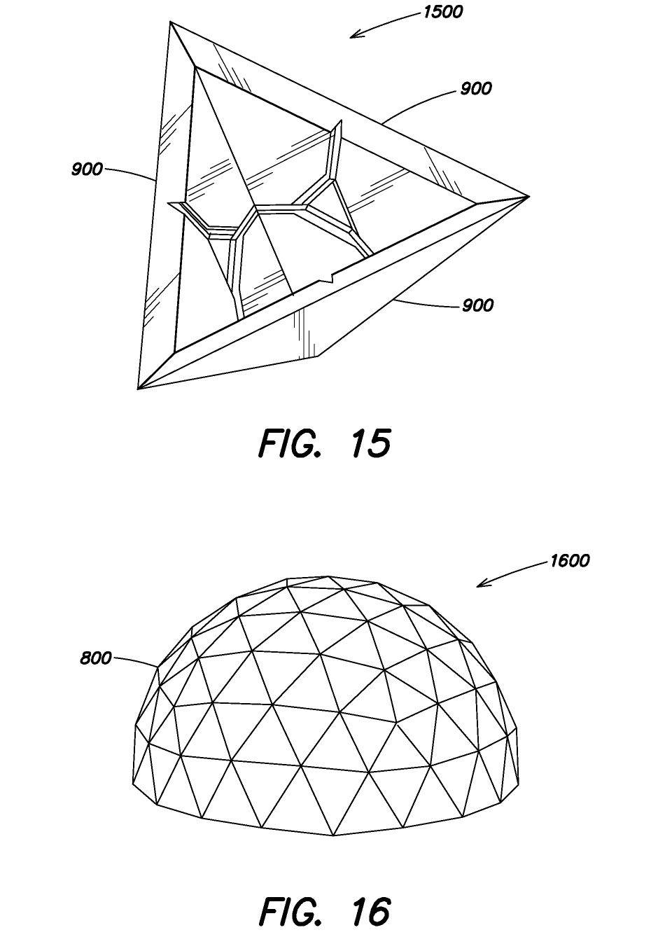

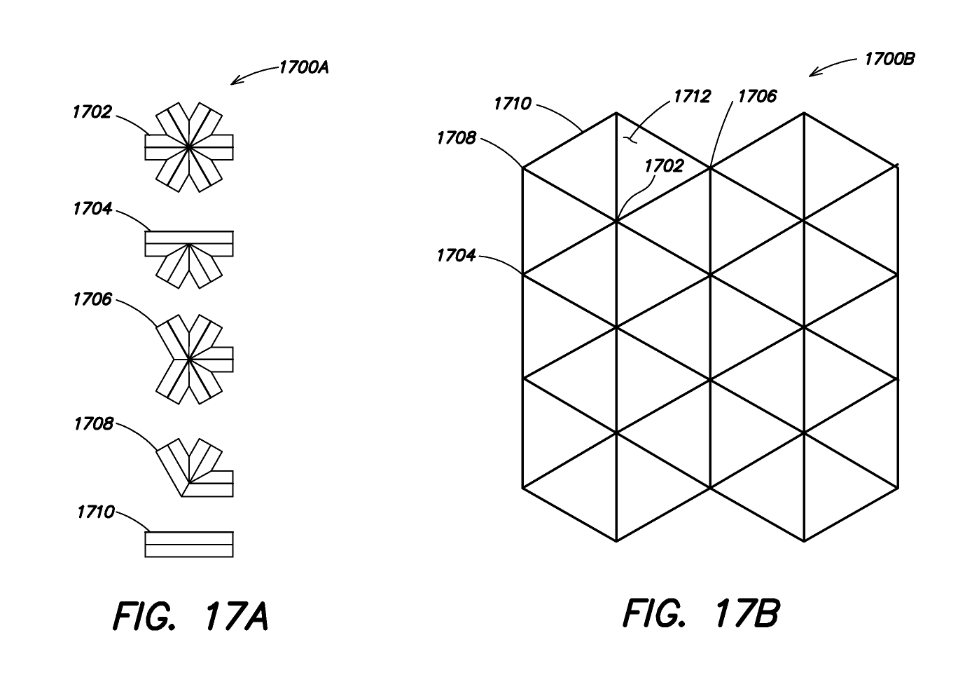

It is appreciated that the designs formed by the modular tiles are not limited to two-dimensional displays. FIGS. 15-16 illustrate example three-dimensional designs that may be implemented through modular tiles. FIG. 15 illustrates an example tetrahedron 1500 implemented via a plurality of coverless tiles 900. FIG. 16 illustrates an example geodesic dome 1600 comprising a plurality of triangular modular tiles 800.

### Example Display Support Structures

According to some embodiments, it is appreciated that the specific design formed by the modular tiles may be determined at least in part by the support structure created to support each modular tile. The support structure may be constructed to define the shape of the display by dictating the placement of the plurality of modular tiles.

FIGS. 17A-B illustrate one embodiment of a modular tile support structure. The modular tile support structure 1700B comprises a plurality of modular connectors 1700A. The modular connectors 1700A include a strut 1710 and a plurality of nodes including a 6-way connector 1702, a 5-way connector 1706, a 4-way connector 1704A, a 3-way connector 1708, and a 2-way connector 1710. These modular connectors may be arranged to support the modular tiles in unique structure. The modular tiles may be placed in receptacles 1712 formed by the various modular connectors 1700A.

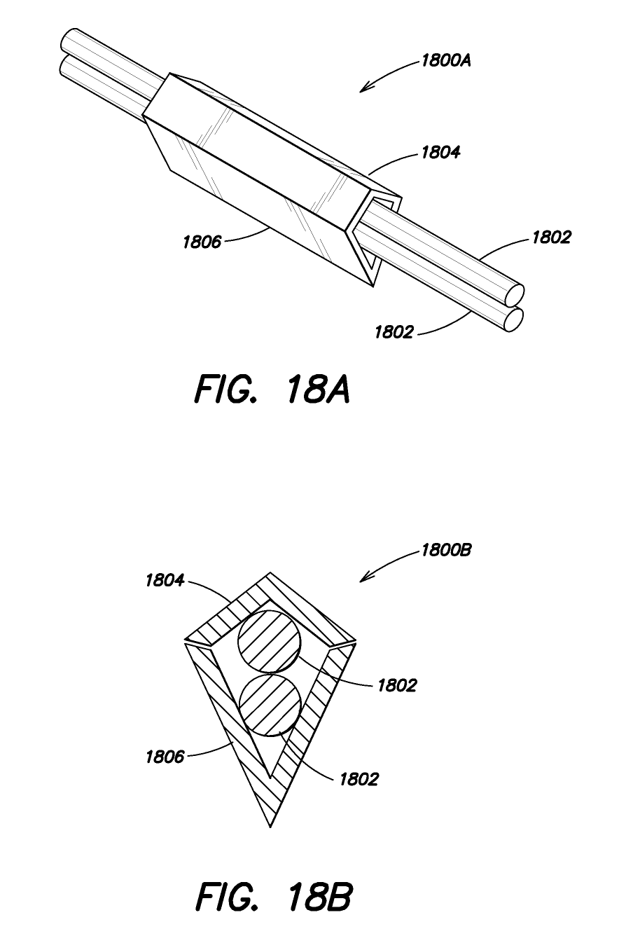

FIGS. 18A-B illustrate one embodiment of a strut (e.g., strut 1710). The strut 1800A comprises a top section 1804 and a bottom section 1806 that form a conduit through which cables 1802 may be placed. FIG. 18B illustrates a strut cross section 1800B.

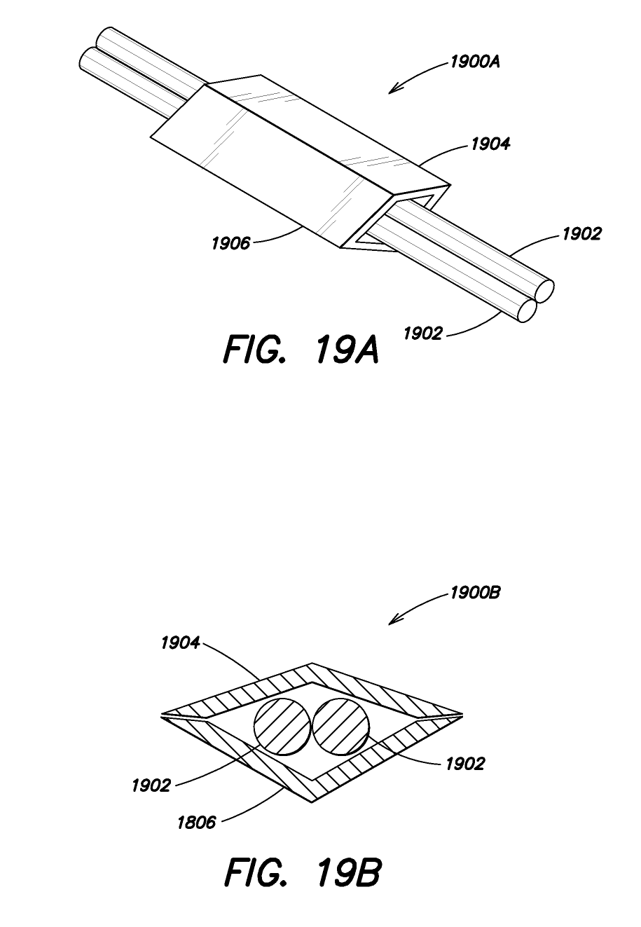

FIGS. 19A-B illustrate one embodiment of a strut (e.g., strut 1710). The strut 1900A comprises a top section 1904 and a bottom section 1906 that form a conduit through which cables 1902 may be placed. FIG. 19B illustrates a strut cross section 1900B.

In some embodiments, the support structure is a metal tray with a plurality of receptacles. In this embodiment, each of the receptacles is sized to receive a single module tile (e.g., a triangular tile). A variety of connection mechanisms may be employed to fasten each tile to the receptacle. For example, the rear surface of the tiles may include one or more threaded holes. Screws can be fastened to the tiles through one or more holes in the metal tray and thereby fasten the tile to the metal tray. In another example, each tray in the metal receptacle includes one or more magnets that hold each modular tile in place.

In other embodiments, the support structure for the modular tiles includes a metal sheet including a plurality of upward facing hooks. In these embodiments, the rear surface of the tile includes a hook receiver. Each tile may be fitted onto the hook via the receptacle on the rear surface.

In some polyhedral embodiments, a support structure of nodes and struts may be employed. The substructure includes a plurality of struts that are attached to the rear face of one or more tiles. These struts are perpendicular relative to the rear face of the one or more tiles. These struts extend inward to one or more central nodes. Each of the central nodes connects a plurality of struts. For example, in one embodiment a nodes and struts support structure is configured to support a tetrahedron. Each of the tiles that comprise the tetrahedron includes a strut that is attached to the tile in a perpendicular fashion relative to the rear face of the time. In this embodiment, the plurality of struts extending inwardly from the various tiles meets at a single central node.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. For example, the modular display tiles disclosed herein may include shapes other than triangular tiles. The modular tile shapes may include, for example, trapezoids, parallelograms, and hexagons.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description, or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

What is claimed is:

1. A Light Emitting Diode (LED) display comprising:
a modular tile having a first surface and a second surface opposite the first surface; and
an array of LEDs disposed on the first surface in a hexagonal grid configuration;
wherein the array of LEDs is configured to provide at least one clean line of separation within the array at a non-right angle.

2. The LED display of claim 1, wherein the array of LEDs disposed on the first surface in the hexagonal configuration includes an array of LED pixels disposed on the first surface in the hexagonal configuration.

3. The LED display of claim 2, wherein each LED pixel of the array of LED pixels includes at least a red LED subpixel, a blue LED subpixel, and a green LED subpixel.

4. The LED display of claim 1, wherein the LEDs disposed on the first side in the hexagonal configuration are 3-fold rotationally symmetric about an axis perpendicular to the first surface.

5. The LED display of claim 1, wherein the modular tile includes a plurality of triangular sub-sections with identical dimensions.

6. The LED display of any of claim 5, wherein each one of the plurality of triangular subsections includes at least one LED disposed at a central point of the triangular subsection.

7. The LED display of claim 5, wherein each of the plurality of triangular subsections is an equilateral triangular subsection and the plurality of triangular subsections form a regular hexagonal grid across the first surface of the modular tile.

8. The LED display of claim 5, wherein each of the plurality of triangular subsections is an isosceles triangular subsection and the plurality of triangular subsections form a stretched hexagonal grid across the first surface of the modular tile.

9. The LED display of claim 5, wherein each of the plurality of triangular subsections is a scalene triangular subsection and the plurality of triangular subsections form a skewed hexagonal grid across the first surface of the modular tile.

10. The LED display of claim 1, wherein the modular tile is a triangular tile.

11. A Light Emitting Diode (LED) display comprising:
a plurality of modular tiles, each of the plurality of tiles having a first surface and a second surface opposite the first surface and further including:
an array of LEDs disposed on the first surface in a hexagonal grid configuration;
wherein the array of LEDs is configured to provide at least one clean line of separation within the array at a non-right angle.

12. The LED display of claim 11, wherein the plurality of modular tiles is configured to present a seamless image across the LED display to a viewer of the LED display.

13. The LED display of claim 12, wherein the array of LEDs of each one of the plurality of modular tiles is arranged to form a continuous hexagonal grid configuration across the plurality of modular tiles to present the seamless image to the viewer of the LED display.

14. The LED display of claim 11, wherein each array of LEDs disposed on the first surface in the hexagonal configuration includes an array of LED pixels disposed on the first surface in the hexagonal configuration.

15. The LED display of claim 14, wherein each LED pixel in the array of LED pixels includes at least a red LED subpixel, a blue LED subpixel, and a green LED subpixel.

16. The LED display of claim 11, wherein the plurality of modular tiles include a plurality of triangular tiles.

17. The LED display of claim 16, wherein the plurality of modular tiles are arranged to form at least one polyhedron.

18. A method for providing an LED display, the method comprising:
providing at least one modular tile having a first surface and a second surface opposite the first surface; and
providing an array of LEDs disposed on the first surface in a hexagonal grid configuration;
wherein the array of LEDs is configured to provide at least one clean line of separation within the array at a non-right angle.

19. The method of claim 18, wherein the LEDs disposed on the first side in the hexagonal configuration are 3-fold rotationally symmetric about an axis perpendicular to the first surface.

20. The method of claim 18, wherein providing at least one modular tile includes providing at least one modular tile that includes a plurality of triangular sub-sections with identical dimensions.
